(19) United States
(12) Patent Application Publication
(10) Pub. No.: US 2011/0295808 A1
(43) Pub. Date: Dec. 1, 2011

(54) HALDB OLR Variant Linear Statistics

(75) Inventors: Sally A. Gehring, Carlsbad, CA (US); Dean L. Grover, Hollister, CA (US); John T. Langley, San Jose, CA (US)

(73) Assignee: INTERNATIONAL BUSINESS MACHINES CORPORATION, Armonk, NY (US)

(21) Appl. No.: 12/789,124

(22) Filed: May 27, 2010

(51) Int. Cl. G06F 17/30

(52) U.S. Cl. 707/640; 707/803; 707/769; 707/E17.005; 707/E17.007; 707/E17.014

(57) ABSTRACT

A method for providing database reorganization statistics across timestamp recoveries, includes: appending statistical data for a database reorganization associated with a timestamp to a statistics file; determining that the database reorganization has resumed after a suspension; obtaining a resume timestamp; retrieving statistical data within the statistics file corresponding to the resume timestamp; and appending statistical data for the resumed database reorganization to the retrieved statistical data. Further raw statistical data for the resumed database reorganization are appended to the retrieved raw statistical data. When a unit of reorganization has committed or the resumed database reorganization has terminated, a statistics record including the retrieved raw statistical data and the further raw statistical data associated with another timestamp is created, and the statistics record is appended to the statistics file.

### BACKGROUND

When data is initially loaded into a database, such as a High Availability Large Database (HALDB), the physical location of each segment is chosen to minimize the number of I/Os needed to access records and segments in the database. As programs modify, insert, and delete segments over time, the cost of accessing the data in the database tends to increase, leading to longer processing times for application programs accessing these databases.

Database reorganization is the process of relocating segments in a database, with the goal of optimizing the I/O cost for accessing the data in the database. An integrated HALDB online reorganization (OLR) allows the reorganization of the HALDB databases while they are concurrently accessed for read or update processing by application programs. The databases are reorganized at the partition level, with each partition independently reorganized. The OLR uses two database data sets during the reorganization process. One or more records, known as a unit of reorganization (UOR), is read from an input data set and then written to an output data set. For possible recovery of either the input or the output data set, all database changes are stored and logged. When changes made to an UOR are committed, the log records are written to recovery control dataset (RECON) records and associated with a timestamp. Included in the log records are change accumulation records, which track the database changes, and statistics records, which contain statistics for the OLR and are recorded for each UOR. The statistics record stores information such as segments moved in this UOR, bytes moved in this UOR, locks held by this UOR, start time of this UOR, execution time of this UOR, and other information.

An OLR can be terminated, or suspended, prior to completion and then resumed. Database recovery can also be performed to a time prior to a completion of an OLR. The database recovery can be a timestamp recovery, where the database is recovered to a pre-defined checkpoint, or a point-in-time recovery (PITR), where the database is recovered to a UOR boundary. Multiple database recoveries may be performed. However, upon resuming the OLR, the statistics records in the RECON that are no longer relevant to the current version of the database are invalidated. Thus, statistical information useful for tracking different versions of the database for an OLR is lost.

### BRIEF SUMMARY

According to one embodiment of the present invention, a method for providing database reorganization statistics across timestamp recoveries, comprises: appending statistical data for a database reorganization associated with a timestamp to a statistics file; determining that the database reorganization has resumed after a suspension; obtaining a resume timestamp; retrieving statistical data within the statistics file corresponding to the resume timestamp; and appending statistical data for the resumed database reorganization to the retrieved statistical data.

In one aspect of the embodiment, when a unit of reorganization has committed, a statistics record comprising raw statistical data for the database reorganization associated with the timestamp is created, and the statistics record is appended to the statistics file.

In one aspect of the embodiment, when the database reorganization is determined to have terminated, a statistics record comprising raw statistical data associated with the timestamp is created. The statistics record is appended to the statistics file. A recovery control dataset record with a database reorganization termination timestamp is created and stored.

In one aspect of the embodiment, when a recovery is determined to have been performed on the database, a recovery control dataset record is created with a recovery timestamp.

In one aspect of the embodiment, a database recovery control utility is queried for the resume timestamp from a recovery control dataset, and the resume timestamp is received from the database recovery control utility.

In one aspect of the embodiment, a statistics record in the statistics file with a timestamp matching the resume timestamp is found, and the raw statistical data for the database reorganization is retrieved from the found statistics record.

In one aspect of the embodiment, further raw statistical data for the resumed database reorganization is appended to the retrieved raw statistical data. When a unit of reorganization has committed, or the resume database reorganization has terminated, a statistics record comprising the retrieved raw statistical data and the further raw statistical data associated with another timestamp is created. The statistics record is appended to the statistics file.

System and computer program products corresponding to the above-summarized methods are also described and claimed herein.

### BRIEF DESCRIPTION OF THE SEVERAL VIEWS OF THE DRAWINGS

FIG. 1 illustrates an embodiment of a system implementing a method for providing database reorganization statistics across timestamp recoveries according to the present invention.

FIG. 2 is a flowchart illustrating an embodiment of the method for providing database reorganization statistics across timestamp recoveries according to the present invention.

FIG. 3 is a flowchart illustrating in more detail the embodiment of the method for providing database reorganization statistics across timestamp recoveries according to the present invention.

FIG. 4 illustrates an example of the method for providing database reorganization statistics across timestamp recoveries according to the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java® (Java, and all Java-based trademarks and logos are trademarks of Sun Microsystems, Inc. in the United States, other countries, or both), Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer special purpose computer or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified local function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

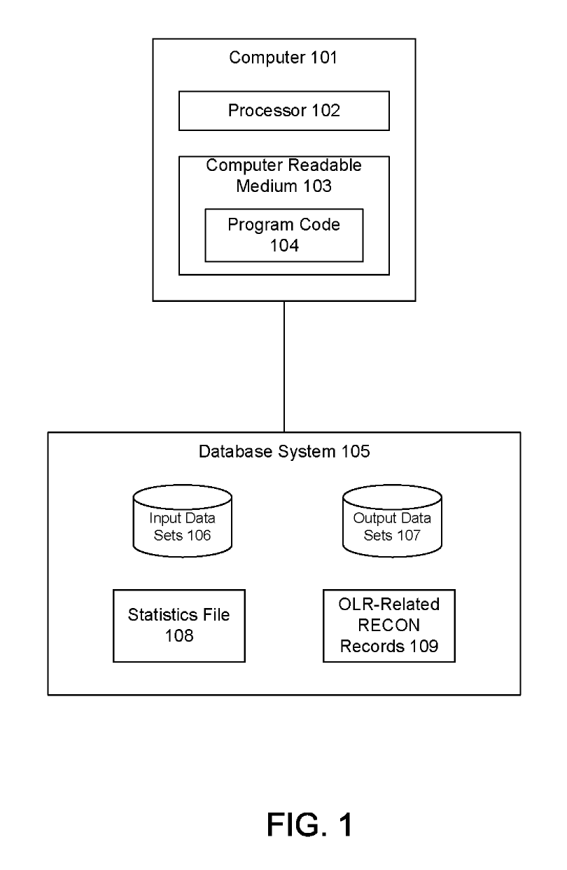

FIG. 1 illustrates an embodiment of a system implementing a method for providing database reorganization statistics across timestamp recoveries according to the present invention. The system includes a computer 101, which is operationally coupled to a processor 102 and a computer readable medium 103. The computer readable medium 103 stores computer readable program code 104 for implementing the method of the present invention. The system further includes a database system 105 on which an online reorganization may be performed. During the online reorganization, a UOR is read from input data sets 106 and then written to output data sets 107. When changes made to an UOR are committed, the OLR-related log records are written to the RECON records 109 and associated with timestamps.

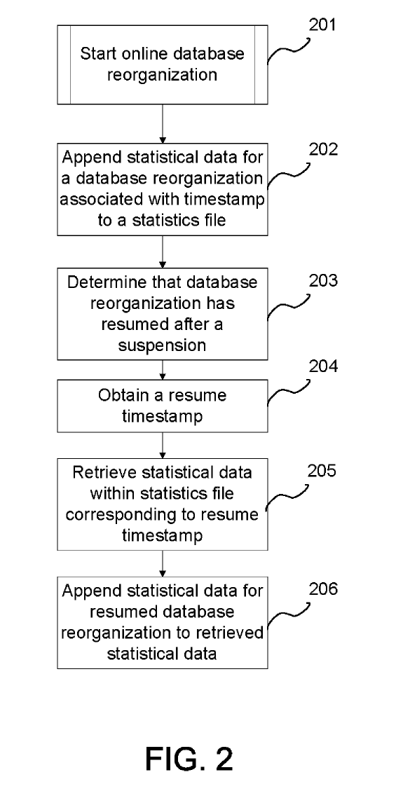

FIG. 2 is a flowchart illustrating an embodiment of the method for providing database reorganization statistics across timestamp recoveries according to the present invention. After an OLR is started (201), statistical data for the OLR associated with a timestamp is appended to a statistics file 108 (202). The statistics file 108 is a separate file from the RECON. A statistics record is stored each time a UOR is committed or the OLR is terminated or suspended. When it is determined that the database reorganization has resumed after a suspension (203), a resume timestamp is obtained (204). In this embodiment, a Database Recovery Control (DBRC) (not shown) is queried to obtain the resume timestamp from the RECON records 109. The DBRC is a utility which provides log control functions and records information about image copies, change accumulations, recoveries, and reorganizations. The statistical data within the statistics file 108 corresponding to the resume timestamp is retrieved (205). In this embodiment, the statistics record in the statistics file 108 associated with a timestamp matching the resume timestamp is determined. The statistical data in this statistical record is then retrieved. Statistical data for the resumed database reorganization is then appended to the retrieved statistical data (206). The statistical data associated with a timestamp is then appended to the statistics file 108 (202), in this embodiment, at a UOR commit or OLR termination. Each time the database reorganization is resumed after a suspension, steps 202-206 are repeated. The database reorganization may be resumed after a normal termination of the reorganization, a timestamp recovery to a time before the completion of the reorganization, or a PITR to a time before the completion of the reorganization. In each of these situations, when the database reorganization is resumed, a new version of the database begins. The statistical data retrieved using the resume timestamp is thus the base statistical data for the new version of the database. By appending to this retrieved statistical data after the database reorganization is resumed, statistical data for the current version of the database are maintained, without invalidating or losing the statistical data pertaining to previous versions of the database.

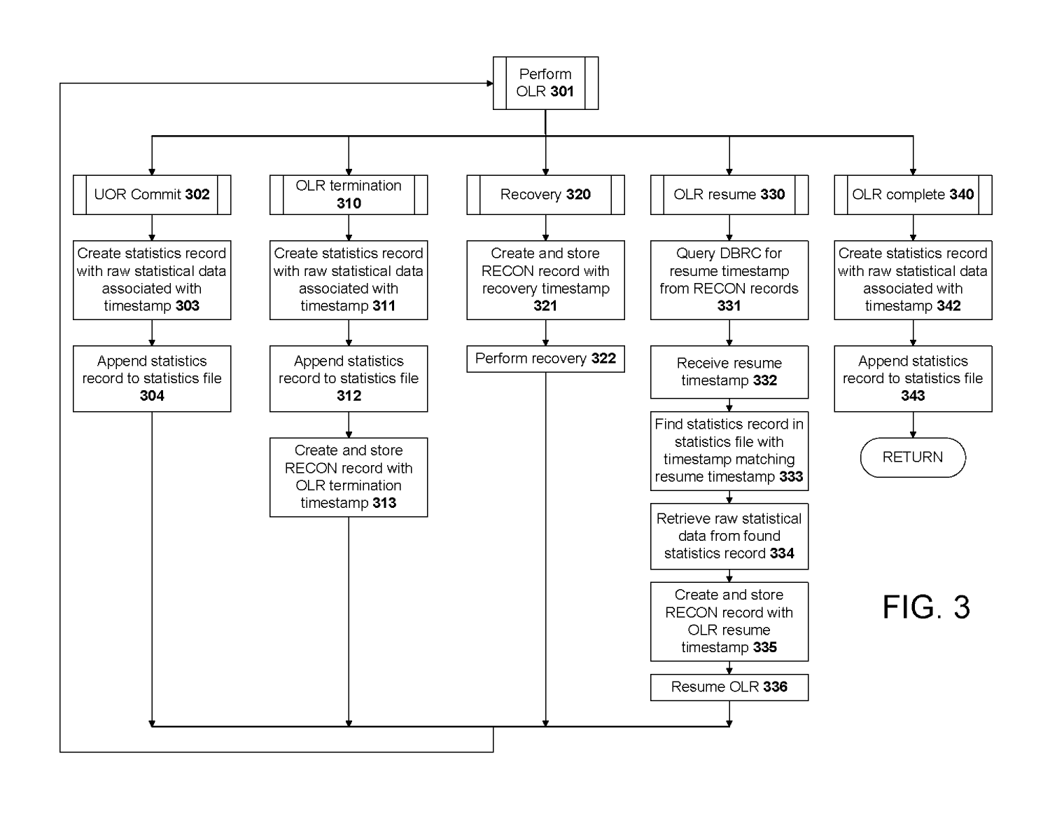

FIG. 3 is a flowchart illustrating in more detail the embodiment of the method for providing database reorganization statistics across timestamp recoveries according to the present invention. During an OLR (301), with each UOR commit (302), a statistics record with raw statistical data associated with a timestamp is created (303). The timestamp here would be the time of the UOR commit. The raw statistical data was accumulated as the UOR was processed. The statistics record is appended to the statistics file 108 (304). When an OLR termination occurs (310), a statistics record with raw statistical data associated with a timestamp is also created (311). The timestamp here would be the time of the OLR termination. The statistics record is appended to the statistics file 108 (312), and a RECON record is created and stored with an OLR termination timestamp (313). In this embodiment, each statistics record includes a high level qualifier of the partition name being reorganized, a middle level qualifier of a timestamp identifier for when the OLR originally started, and a low level qualifier indicating the raw statistical data.

When a database recovery occurs (320), a RECON record for the recovery is created and associated with a recovery timestamp (321), and the database recovery is performed (322). In this embodiment, either a timestamp recovery or a point-in-time recovery (PITR) may be performed. With a timestamp recovery, the database is recovered to a previous checkpoint created by the DBRC. With a PITR recovery, the database is recovered to a previous UOR boundary.

When the OLR is resumed (330) after a previous OLR termination or database recovery, the DBRC is queried to obtain a resume timestamp from the RECON records 109 (331). If the OLR is resumed after an OLR termination, then the resume timestamp is the time of the OLR termination. If the OLR is resumed after a database recovery, then the resume timestamp is the time to which the database was recovered. When the resume timestamp is received (332), the statistics record in the statistics file 108 with a timestamp matching the resume timestamp is found (333). The raw statistical data from this found statistics record is then retrieved (334). A RECON record for the OLR resume is created and stored with an OLR resume timestamp (335), and the OLR is resumed (336). In this embodiment, the raw statistical data is read into memory, and further raw statistical data during the processing of a UOR are collected and appended. Upon a subsequent UOR commit (302) or OLR termination (310), a new statistics record containing this raw statistical data is created (303, 311) and appended to the statistics file 108 (304, 312). In this manner, each version of the database has its own set of statistics records. Statistical information is not lost due to an OLR termination or database recovery.

When the OLR completes (340), a statistics record with raw statistical data associated with a timestamp is created (341). The statistics record is appended to the statistics file 108 (342).

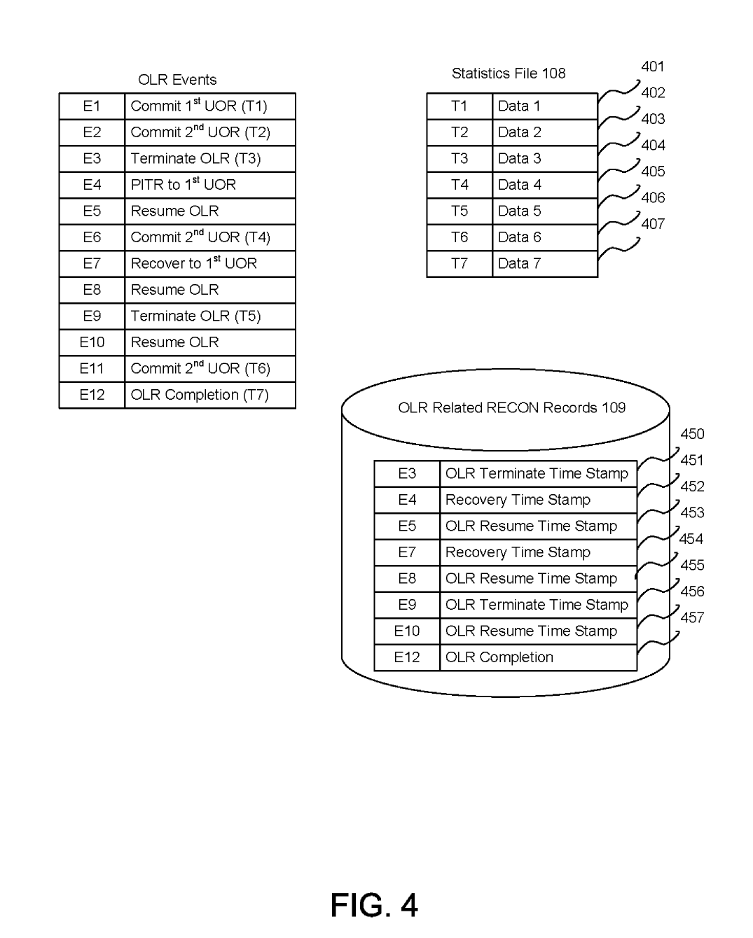

FIG. 4 illustrates an example of the method for providing database reorganization statistics across timestamp recoveries according to the present invention. Assume a series of OLR events E1-E12. Referring to both FIGS. 3 and 4, E1 is a commit of a 1^{st} UOR at time T1 (302). A statistics record 401 with raw statistical data for E1 (Data 1) associated with the timestamp T1 is created (303). The statistics record 401 is appended to the statistics file 108 (304).

E2 is a commit of a second UOR at time T2 (302). A statistics record 402 with raw statistical data for E1 and E2 (Data 2) associated with the timestamp T2 is created (303). The statistics record 402 is appended to the statistics file 108 (304). E3 is an OLR termination at time T3 (310). A statistics record 403 with raw statistical data for E1, E2, and E3 (Data 3) associated with the timestamp T3 is created (311). The statistics record 403 is appended to the statistic file 108 (312). A RECON record 450 is created and stored with an OLR termination timestamp T3 (313).

E4 is a PITR to the first UOR (320). A RECON record 451 associated with a recovery timestamp T1 is created for the PITR (321), and the PITR is performed (322).

E5 is an OLR resume (330). The DBRC is queried for the resume timestamp from the RECON records 109 (331). The recovery timestamp T1 from RECON record 451 is received as the resume timestamp (332). The statistics record 401 in the statistics file 108 is found to have a timestamp matching T1 (333). The raw statistical data (Data 1) from statistics record 401 is retrieved (334). A RECON record 452 is created and stored for E5 with an OLR resume timestamp (335), and the OLR is resumed (336). After the PITR, database events E2 and E3 belong to a previous version of the database. Thus, statistics record 401 contains the base raw statistics data for the current version of the database. For this reason, the collection of statistical data for the current version of the database begins with the statistical data in statistics record 401. The statistics records 402 and 403 are not relevant to the current database version but are still relevant to the previous database version, so the statistics records 402-403 are maintained in the statistics file 108. In this manner, the statistics file 108 maintains statistical data for multiple versions of the database.

E6 is a commit of a second UOR for the current version of the database at time T4 (302). A statistics record 404 with raw statistical data for E1 and E6 (Data 4) associated with the timestamp T4 is created (303). The statistics record 404 is appended to the statistics file 108 (304). Assuming that a checkpoint was created at the boundary of the 1^{st} UOR, E7 is a timestamp recovery to the first UOR (320). A RECON record 453 is created and stored for the recovery with a recovery timestamp T1 (321), and the recovery is performed (322).

E8 is the resuming of the OLR (330) after the timestamp recovery E7. The DBRC is queried for the resume timestamp from the RECON records 109 (331). The recovery timestamp T1 from RECON record 453 is received as the resume timestamp (332). The statistics record 401 in the statistics file 108 is found to have a timestamp matching T1 (333). The raw statistical data (Data 1) from statistics record 401 is retrieved (334). A RECON record 454 is created and stored for E8 with an OLR resume timestamp (335), and the OLR is resumed (336).

E9 is an OLR termination at time T5 (310). A statistics record 405 with raw statistics data for E1 and E9 (Data 5) associated with timestamp T5 is created (311). The statistics record 405 is appended to the statistics file 108 (312). A RECON record 455 is created and stored with an OLR termination timestamp (313).

E10 is an OLR resume (330). The DBRC is queried for the resume timestamp from the RECON records 109 (331). The timestamp T5 from RECON record 455 is received as the resume timestamp (332). The raw statistical data (Data 5) in statistics record 405 is retrieved (334). A RECON record 456 is created and stored for E10 with an OLR resume timestamp (335), and the OLR is resumed (336).

E11 is a commit of a second UOR at time T6 (302). In the current version of the database, a previous timestamp recovery (E7) rolled the database back to the first UOR. Thus, the current UOR commit is for a second UOR. A statistics record 406 with raw statistical data for E1, E9, and E11 (Data 6) associated with the timestamp T6 is created (303). The statistics record 406 is appended to the statistics file 108 (304).

E12 is the completion of the OLR at time T7 (340). A statistics record 407 with raw statistical data for E1, E9, E11, and E12 (Data 7) associated with timestamp T7 is created (341). The statistics record 407 is appended to the statistics file 108 (342). Note that in this example, Data 1 and Data 6 are subsets of Data 7, while Data 2, Data 3, and Data 4 are not used in the version of the database at OLR completion.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for providing database reorganization statistics across timestamp recoveries, comprising:
appending statistical data for a database reorganization associated with a timestamp to a statistics file;
determining that the database reorganization has resumed after a suspension;
obtaining a resume timestamp;
retrieving statistical data within the statistics file corresponding to the resume timestamp; and
appending statistical data for the resumed database reorganization to the retrieved statistical data.

2. The method of claim 1, wherein the appending the statistical data for the database reorganization associated with the timestamp to the statistics file comprises:
determining that a unit of reorganization has committed;
creating a statistics record comprising raw statistical data for the database reorganization associated with the timestamp; and
appending the statistics record to the statistics file.

3. The method of claim 1, wherein the appending the statistical data for the database reorganization associated with the timestamp to the statistics file comprises:
determining that the database reorganization has terminated;
creating a statistics record comprising raw statistical data associated with the timestamp;
appending the statistics record to the statistics file; and
creating and storing a recovery control dataset record with a database reorganization termination timestamp.

4. The method of claim 1, wherein the determining that the database reorganization has resumed after the suspension comprises:
determining that a recovery is performed on the database; and
creating and storing a recovery control dataset record with a recovery timestamp.

5. The method of claim 1, wherein the obtaining the resume timestamp comprises:
querying a database recovery control utility for the resume timestamp from a recovery control dataset; and
receiving the resume timestamp from the database recovery control utility.

6. The method of claim 1, wherein the retrieving the statistical data within the statistics file corresponding to the resume timestamp comprises:
finding a statistics record in the statistics file with a timestamp matching the resume timestamp; and
retrieving raw statistical data for the database reorganization from the found statistics record.

7. The method of claim 1, wherein the appending the statistical data for the resumed database reorganization to the retrieved statistical data comprises:
appending further raw statistical data for the resumed database reorganization to the retrieved raw statistical data;
determining that a unit of reorganization has committed or the resumed database reorganization has terminated;
creating a statistics record comprising the retrieved raw statistical data and the further raw statistical data associated with another timestamp; and
appending the statistics record to the statistics file.

8. A computer program product for providing database reorganization statistics across timestamp recoveries, the computer program product comprising:
a computer readable storage medium having computer readable program code embodied therewith, the computer readable program code comprising computer readable program code configured to:
append statistical data for a database reorganization associated with a timestamp to a statistics file;
determine that the database reorganization has resumed after a suspension;
obtain a resume timestamp;
retrieve statistical data within the statistics file corresponding to the resume timestamp; and
append statistical data for the resumed database reorganization to the retrieved statistical data.

9. The computer program product of claim 8, wherein the computer readable program code configured to append the statistical data for the database reorganization associated with the timestamp to the statistics file is further configured to:
determine that a unit of reorganization has committed;
create a statistics record comprising raw statistical data for the database reorganization associated with the timestamp; and
append the statistics record to the statistics file.

10. The computer program product of claim 8, wherein the computer readable program code configured to append the statistical data for the database reorganization associated with the timestamp to the statistics file is further configured to:
determine that the database reorganization has terminated;
create a statistics record comprising raw statistical data associated with the timestamp;
append the statistics record to the statistics file; and
create and store a recovery control dataset record with a database reorganization termination timestamp.

11. The computer program product of claim 8, wherein the computer readable program code configured to determine that the database reorganization has resumed after the suspension is further configured to:
determine that a recovery is performed on the database; and
create and store a recovery control dataset record with a recovery timestamp.

12. The computer program product of claim 8, wherein the computer readable program code configured to obtain the resume timestamp is further configured to:
query a database recovery control utility for the resume timestamp from a recovery control dataset; and
receive the resume timestamp from the database recovery control utility.

13. The computer program product of claim 8, wherein the computer readable program code configured to retrieve the statistical data within the statistics file corresponding to the resume timestamp is further configured to:
find a statistics record in the statistics file with a timestamp matching the resume timestamp; and
retrieve raw statistical data for the database reorganization from the found statistics record.

14. The computer program product of claim 8, wherein the computer readable program code configured to append the statistical data for the resumed database reorganization to the retrieved statistical data is further configured to:
append further raw statistical data for the resumed database reorganization to the retrieved raw statistical data;
determine that a unit of reorganization has committed or the resumed database reorganization has terminated;
create a statistics record comprising the retrieved raw statistical data and the further raw statistical data associated with another timestamp; and
append the statistics record to the statistics file.

15. A system, comprising:
a database; and
a computer operationally coupled to the database and comprising a computer readable storage medium having computer readable program code embodied therewith, the computer readable program code comprising computer readable program code configured to:
append statistical data for a database reorganization associated with a timestamp to a statistics file;
determine that the database reorganization has resumed after a suspension;
obtain a resume timestamp;
retrieve statistical data within the statistics file corresponding to the resume timestamp; and
append statistical data for the resumed database reorganization to the retrieved statistical data.

16. The system of claim 15, wherein the computer readable program code configured to append the statistical data for the database reorganization associated with the timestamp to the statistics file is further configured to:
determine that a unit of reorganization has committed;
create a statistics record comprising raw statistical data for the database reorganization associated with the timestamp; and
append the statistics record to the statistics file.

17. The system of claim 15, wherein the computer readable program code configured to append the statistical data for the database reorganization associated with the timestamp to the statistics file is further configured to:
determine that the database reorganization has terminated;
create a statistics record comprising raw statistical data associated with the timestamp;
append the statistics record to the statistics file; and
create and store a recovery control dataset record with a database reorganization termination timestamp.

18. The system of claim 15, wherein the computer readable program code configured to determine that the database reorganization has resumed after the suspension is further configured to:
determine that a recovery is performed on the database; and
create and store a recovery control dataset record with a recovery timestamp.

19. The system of claim 15, wherein the computer readable program code configured to obtain the resume timestamp is further configured to:
query a database recovery control utility for the resume timestamp from a recovery control dataset; and
receive the resume timestamp from the database recovery control utility.

20. The system of claim 15, wherein the computer readable program code configured to retrieve the statistical data within the statistics file corresponding to the resume timestamp is further configured to:
find a statistics record in the statistics file with a timestamp matching the resume timestamp; and
retrieve raw statistical data for the database reorganization from the found statistics record.
